(19) United States
(12) Patent Application Publication
(10) Pub. No.: US 2006/0080436 A1
(43) Pub. Date: Apr. 13, 2006

(54) System and method for multimedia streaming using interleaved packetization

(75) Inventors: Ru-Shang Wang, Coppell, TX (US); Keith Miller, Plano, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/960,151

(22) Filed: Oct. 7, 2004

(51) Int. Cl. G06F 15/173

(52) U.S. Cl. 709/225

(57) ABSTRACT

Methods, devices, systems, program products and computer-implemented methods for communication of non-interleaved and interleaved packets of streamed data are disclosed. A method of streaming multimedia includes transmitting a signal from a client device to a multimedia server. The signal is indicative of desired settings for the client device to receive packets of streamed data. The desired settings include at least one of an amount of a total buffer memory allocated to buffering of interleaved packets and an indication of acceptability of all packetization types available to the server.

### FIELD OF THE INVENTION

The present invention relates to multimedia streaming. In particular, the invention provides systems and methods for facilitating multimedia streaming using interleaved packets.

### BACKGROUND OF THE INVENTION

In a multimedia streaming system, upon receiving a request from a client device, a server computer transmits a stream of data to the client device. The data may be sent through any of a variety of communication networks, such as the Internet or a wireless communication network. In streaming applications delivering typical audio or video content, time-based delivery is essential.

Data is typically transmitted by the server computer as packets of data using the Realtime Transport Protocol (RTP) in accordance with the 3^{rd} Generation Partnership Project (3GPP) Packet Switched Streaming Service (PSS) requirements. RTP is a packet format for multimedia data streams defining the necessary client-server interaction to stream different types of multimedia presentations. The RTP packets may be transmitted in the order in which they are to be decoded. In this regard, a packet may correspond to a frame of a video clip, for example. Thus, when the data is received by the client device, the packets are decoded and played in the order they were transmitted by the server computer.

In order to accommodate delays in the transmission between the server computer and the client device, as may occur due to bottlenecks in the network, a buffer memory may be provided in the client device. The buffer memory may be at least partially filled before the client device begins decoding the packets for presentation to the user. The buffer allows for uniform presentation of the data despite non-uniform transmission between the server computer and the client device.

The streaming of the data can be enhanced by interleaving the packets. In this regard, each packet may include data corresponding to two or more frames, for example. Thus, the data may not be transmitted in the same order in which it is to be presented to the user. When such interleaved packets are received by the client device, they may be required to be stored until all packets associated with a particular frame are received and can be decoded. Thus, the client device may be required to be provided with additional memory, which can increase the cost and size of the client device.

### SUMMARY OF THE INVENTION

The present invention is directed to methods, devices, systems, program products, and computer-implemented methods adapted for communication of non-interleaved and interleaved packets of streamed data.

In one embodiment, a method of streaming multimedia includes transmitting a signal from a client device to a multimedia server. The signal is indicative of desired settings for the client device to receive packets of streamed data. The desired settings include at least one of an amount of a total buffer memory allocated to buffering of interleaved packets and an indication of acceptability of all packetization types available to the server.

In another embodiment, a client device adapted to receive streamed data includes a communication module adapted to receive packets of streamed data from a server; a data decoder adapted to decode the packets of streamed data for presentation to a user; and a buffer memory adapted to buffer the streamed packets between the data receiving module and the data decoder. A portion of the buffer memory is allocated to buffering of interleaved packets.

In another embodiment, a system for multimedia streaming includes a server computer adapted to transmit packets of streamed data, and a client device adapted to receive the packets of streamed data. The client device is configured to transmit a signal to the server computer indicating desired settings for receiving the packets. The desired settings include at least one of an amount of a total buffer memory allocated to buffering of interleaved packets and an indication of acceptability of all packetization types available to the server.

Another embodiment of the invention includes a program product having machine readable program code for causing a machine to perform the following: transmitting a signal from a client device to a multimedia server, the signal being indicative of desired settings for the client device to receive packets of streamed data, wherein the desired settings include at least one of an amount of a total buffer memory allocated to buffering of interleaved packets and an indication of acceptability of all packetization types available to the server.

In another embodiment, a computer-implemented method includes transmitting a signal from a client device to a multimedia server, the signal being indicative of desired settings for the client device to receive packets of streamed data, wherein the desired settings include at least one of an amount of a total buffer memory allocated to buffering of interleaved packets and an indication of acceptability of all packetization types available to the server.

In another embodiment, a client device adapted to receive streamed data includes a communication module adapted to receive packets of streamed data from a server; a data decoder adapted to decode the packets of streamed data for presentation to a user; and a buffer memory adapted to buffer the streamed packets between the data receiving module and the data decoder. The communication module is adapted to transmit a signal to a multimedia server indicating desired settings for receiving packets of streamed data. The desired settings include at least one of an amount of the buffer memory allocated to buffering of interleaved packets and an indication of acceptability of all packetization types available to the server.

Other principle features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings, in which:

FIG. 1 is a diagrammatic representation of a system for multimedia streaming in accordance with an exemplary embodiment; and

FIGS. 2A and 2B are diagrammatic representations of a buffer memory in accordance with exemplary embodiments.

### DETAILED DESCRIPTION OF EXEMPLARY EMBODIMENTS

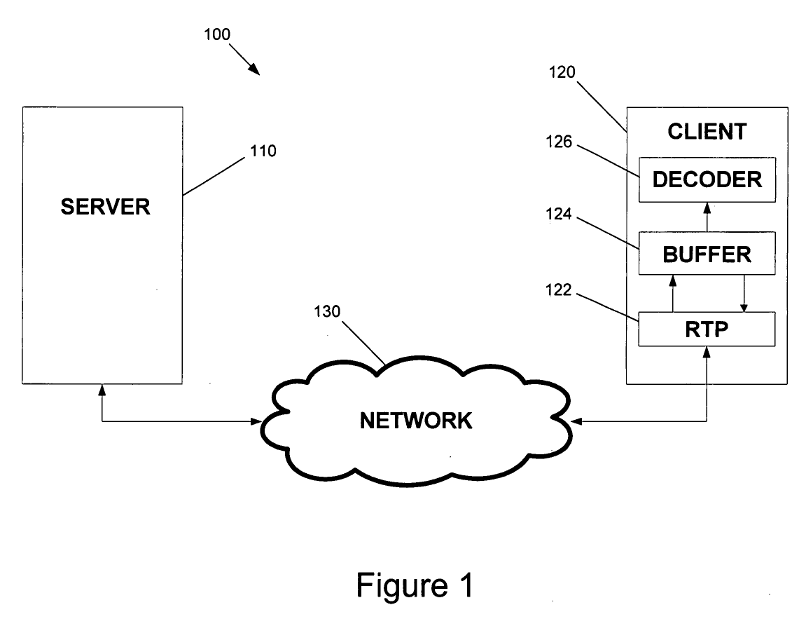

FIG. 1 is a diagrammatic representation of a system for multimedia streaming in accordance with an exemplary embodiment. The system 100 includes a server computer 110 adapted to transmit streamed data to one or more client devices, such as client device 120. The data may be transmitted through any number of communication systems, including networks, such as a communication network 130. The communication network 130 may be a public communication network, such as the Internet, or a wireless communication network, such as a cellular telephone network.

The server 110 may be adapted to provide any type of streamed data, including audio, video or a combination thereof. The server 110 may be adapted to send RTP packets. In this regard, the server 110 may include one or more components (not shown) to encode data for streaming. In this regard, the server 110 is adapted to encode the data in interleaved or non-interleaved packets for streaming.

The packets of data are transmitted to the client 120, where they are initially received by a communication module 122 adapted to receive RTP packets. The communication module 122 may be adapted to de-interleave the interleaved packets and store the de-interleaved data in a buffer memory 124.

The de-interleaving of the packets may require the communication module 122 to temporarily store the packets before they can be de-interleaved. This may occur, for example, if a complete frame cannot be assembled because only a part of the data required for the complete frame has been received in one or more interleaved packets. Until the remainder of the data for the frame is received in another interleaved packet, the data must be stored. In this regard, the interleaved, or unassembled, data can be stored in the buffer memory 124 and be retrieved when the remainder of the data is received, as indicated by the two-way arrows between the communication module 122 and the buffer memory 124.

When the interleaved packages are de-interleaved and frame data is assembled, it can be stored in the buffer memory 124. A decoder 126 can decode the assembled data for presentation to the user. The decoder 126 may retrieve the assembled data from the buffer memory 124 in the order to be presented to the user.

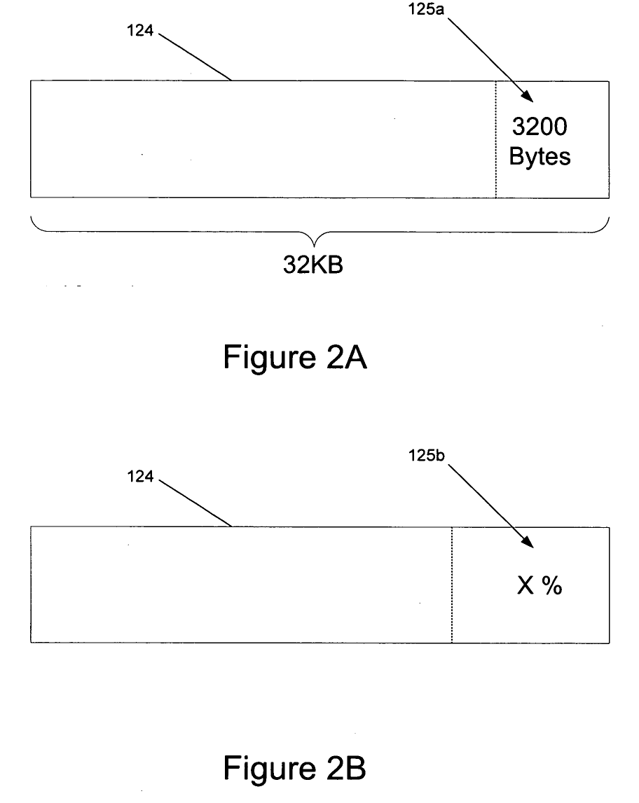

FIGS. 2A and 2B are diagrammatic representations of a buffer memory in accordance with exemplary embodiments. As indicated in FIGS. 2A and 2B, a portion of the buffer memory may be allocated to store the interleaved packets, or unassembled data. In one embodiment, as illustrated in FIG. 2A, the amount of buffer memory allocated to store the interleaved packets is expressed as a fixed quantity, such as a number of bytes. In the illustrated example, 3200 bytes of memory is allocated for this purpose, as may be the case for an H.264 media type.

In the embodiment illustrated in FIG. 2B, the amount of buffer memory allocated for storage of interleaved packets is expressed as a percentage of the total buffer memory. In one example, ten percent of the memory is allocated for interleaved packets. In particular embodiments, the amount of buffer memory allocated for interleaved packets may be between zero and ten percent of the total buffer memory. Of course, other embodiments may allocate different amounts of the buffer memory for interleaved packets as required. An amount of buffer memory allocated for interleaved packets set at zero may indicate that the client device cannot accommodate interleaved packetization.

In accordance with embodiments of the invention, when a client device is connected to a server computer, the client device informs the server of its capabilities, or desired settings, in relation to packetization of streamed data. In this regard, the client device may transmit a signal to announce to the server such desired settings.

In one embodiment, the signal may include a media-level attribute associated with RTP interleaving. The attribute may have the form:
a=3GPP−rtpinterleaving:<media type>; <memory>

In the above example, the parameter <media type> identifies the media type, such as H.264 video media type or AMR audio media type.

The parameter <memory> identifies the amount of memory in the buffer memory that is allocated for interleaved packets. In other words, the parameter defines the portion of the buffer memory that is allocated for this purpose. The total size of the buffer memory may be defined using another parameter. As noted above, this amount of memory allocated for interleaved packets may be expressed as a number of bytes or as a percentage of the total buffer memory.

For example, the attribute may have the following value:
a=3GPP−rtpinterleaving:H.264;3200

In this example, the client device indicated a media type of H.264, and the memory allocated for interleaved packets is 3200 bytes. In another example, the attribute may have the following value:
a=3GPP−rtpinterleaving:H.264;per10

In this example, the amount of memory allocated for interleaved packets is ten percent of the total buffer memory.

The parameter <memory> serves to limit the amount of memory that can be used for interleaved packets. By notifying the server of this limit, the server is provided with information which may guide the selection of a packetization type to be used for streaming data.

In conventional systems, the MIME/SDP parameter “packetization-mode” can only specify a certain mode to use. Thus, a conventional signal may indicate that mode 2 is acceptable, thereby indicating the acceptance of packetization types 25-29. If additional packetization types are to be accommodated, such as packetization types 1-23, a second signal must be sent.

In accordance with embodiments of the present invention, a single signal may indicate that all packetization types are acceptable. Thus, in one embodiment, the attribute may have one of the following forms:
a=3GPP−avcrtpinterleaving or
a=3GPP−avcrtpinterleaving:<memory>

In above examples, the avcrtpinterleaving indicates that the device can accommodate and support all AVC RTP packetization types. As with the previous example, the parameter <memory> identifies the amount of memory in the buffer memory that is allocated for interleaved packets. For example, the attribute may have the following value:
a=3GPP−avcrtpinterleaving:3200

In this example, the client device indicates support of all media types, and the memory allocated for interleaved packets is 3200 bytes.

In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

What is claimed is:

1. A method for multimedia streaming, comprising:
transmitting a signal from a client device to a multimedia server, the signal being indicative of desired settings for the client device to receive packets of streamed data,
wherein the desired settings include at least one of an amount of a total buffer memory allocated to buffering of interleaved packets and an indication of acceptability of all packetization types available to the server.

2. The method of claim 1, wherein the amount of buffer memory allocated to interleaved packets is expressed as a number of bytes.

3. The method of claim 1, wherein the amount of buffer memory allocated to interleaved packets is expressed as a percentage of the total buffer memory.

4. The method of claim 1, further comprising:
selecting a packetization type by the server for transmitting the streamed data, the selecting being based on the signal from the client device.

5. The method of claim 4, wherein the packetization type selected corresponds to the desired settings.

6. The method of claim 1, wherein the desired settings further include one or more packetization types which can be accommodated by the client device.

7. A client device adapted to receive streamed data, the device comprising:
a communication module adapted to receive packets of streamed data from a server;
a data decoder adapted to decode the packets of streamed data for presentation to a user; and
a buffer memory adapted to buffer the streamed packets between the data receiving module and the data decoder, a portion of the buffer memory being allocated to buffering of interleaved packets.

8. The device of claim 7, wherein the device is a mobile device.

9. The device of claim 7, wherein the device includes a mobile phone.

10. The device of claim 7, wherein the portion of the buffer memory allocated to buffering of interleaved packets is zero.

11. The device of claim 7, wherein the communication module is adapted to transmit a signal to a multimedia server indicating desired settings for receiving packets of streamed data, the desired settings including the portion of the buffer memory allocated to buffering of interleaved packets.

12. The device of claim 11, wherein the portion of buffer memory allocated to interleaved packets is expressed as a number of bytes.

13. The device of claim 11, wherein the amount of buffer memory allocated to interleaved packets is expressed as a percentage of the total buffer memory.

14. The device of claim 10, wherein the desired settings further include one or more packetization types which can be accommodated by the client device.

15. A system for multimedia streaming, comprising:
a server computer adapted to transmit packets of streamed data; and
a client device adapted to receive said packets of streamed data, the client device being configured to transmit a signal to the server computer indicating desired settings for receiving the packets, the desired settings including at least one of an amount of a total buffer memory allocated to buffering of interleaved packets and an indication of acceptability of all packetization types available to the server.

16. The system of claim 15, wherein the device is a mobile device.

17. The system of claim 15, wherein the device includes a mobile phone.

18. The system of claim 15, wherein the packets of streamed data are transmitted by the server to the client device through a communication network.

19. The system of claim 18, wherein the communication network is a wireless network.

20. A program product, comprising machine readable program code for causing a machine to perform the following:
transmitting a signal from a client device to a multimedia server, the signal being indicative of desired settings for the client device to receive packets of streamed data,
wherein the desired settings include at least one of an amount of a total buffer memory allocated to buffering of interleaved packets and an indication of acceptability of all packetization types available to the server.

21. A computer-implemented method, comprising:
transmitting a signal from a client device to a multimedia server, the signal being indicative of desired settings for the client device to receive packets of streamed data,
wherein the desired settings include at least one of an amount of a total buffer memory allocated to buffering of interleaved packets and an indication of acceptability of all packetization types available to the server.

22. A client device adapted to receive streamed data, the device comprising:
a communication module adapted to receive packets of streamed data from a server;
a data decoder adapted to decode the packets of streamed data for presentation to a user; and
a buffer memory adapted to buffer the streamed packets between the data receiving module and the data decoder;
wherein the communication module is adapted to transmit a signal to a multimedia server indicating desired settings for receiving packets of streamed data, the desired settings including at least one of an amount of the buffer memory allocated to buffering of interleaved packets and an indication of acceptability of all packetization types available to the server.
